(19) United States
(12) Patent Application Publication
(10) Pub. No.: US 2013/0344276 A1
(43) Pub. Date: Dec. 26, 2013

(54) Heat Resistant Adhesive Tape

(71) Applicant: tesa SE, Hamburg (DE)

(72) Inventors: Karsten Seitz, Buxtehude (DE); Jennifer Kipke, Hamburg (DE); Alexander Prenzel, Hamburg (DE); Lars Sonnenberg, Hamburg (DE)

(21) Appl. No.: 13/922,876

(22) Filed: Jun. 20, 2013

(30) Foreign Application Priority Data
Jun. 21, 2012 (DE) 10 2012 210 511.5
May 27, 2013 (DE) 10 2013 209 827.8

(51) Int. Cl. C09J 7/00

(52) U.S. Cl. CPC C09J 7/00
USPC 428/41.8; 428/220

(57) ABSTRACT

The aim is to achieve enhanced, and more particularly more stable, adhesive bonds or seals of substrates having different characteristics under thermal load. This aim is accomplished by provision of an adhesive tape having a thickness of at least 150 μm, and exhibiting after storage at 120-150° C. over 60 to 210 days an extendability in machine direction of at least three times its original extent.

The invention relates to the technical field of adhesive tapes of the kind used for the temporary or long-term joining of substrates, such as of components, for example. Proposed more particularly are adhesive tapes suitable for the permanent joining of substrates having different thermal characteristics.

For a variety of areas of application, such as in the construction sector, in the industrial manufacture of technical products, or for assembly purposes, for example, increasingly thick yet strongly bonding adhesive tapes (so-called “adhesive assembly tapes” for example) are required. Since the bonds or seals are frequently implemented outdoors and the bonded products are therefore exposed to the effects of weathering, the expectations concerning the properties of such adhesive tapes are high: accordingly the bond is to be strong, durable and weathering-resistant and often, furthermore, it is to have high moisture resistance, heat resistance, and heat-and-humidity resistance. In addition, the adhesive tapes ought to be able to compensate unevennesses in the bonded joint or on the substrates to be bonded, and increasingly, for thick adhesive tapes as well, high transparency is desired—in the area, for instance, of the bonding of transparent materials such as glasses or certain plastics.

The adhesive tapes used for such purposes are commonly furnished with adhesives, for which the technical adhesive properties must be very well tailored to one another. For instance, cohesion, tack, flow behaviour and other properties must be very precisely adjusted. Since the technical forms of the pressure-sensitive adhesive that influence the performance of the adhesive tape often have mutually opposed effects on the individual properties, tailoring is generally difficult, and it is often necessary to accept compromises in the outcome.

Materials having viscoelastic properties that are suitable for pressure-sensitive adhesives are distinguished in that they are suitable for reacting to mechanical deformation both with viscous flow and with elastic forces of resilience. Both processes are in a certain ratio to one another in terms of their respective proportion, depending not only on the precise composition, structure and degree of crosslinking of the material in question, but also on the rate and duration of the deformation, and on the temperature as well.

The proportional viscous flow is necessary in order to achieve adhesion. Only the viscous proportions, brought about by macromolecules having a relatively high mobility, allow effective wetting and effective flow onto the substrate to be bonded. A high viscous flow component results in a high inherent tack and hence often in a high bond strength as well. Highly crosslinked systems, crystalline polymers or polymers that have undergone glass-like solidification are generally not inherently tacky, for lack of flowable components.

The proportional elastic forces of resilience are necessary in order to achieve cohesion. They are brought about, for example, by very long-chain macromolecules with a high degree of entanglement and also by physically or chemically crosslinked macromolecules, and allow transmission of the forces which engage upon an adhesive bond. Their result is that an adhesive bond is able to withstand sufficiently, over a relatively long period of time, a long-term load acting on it, in the form, for example, of a long-term shearing load.

In order to prevent flow-off (a downwards running) of the pressure-sensitive adhesives from the substrate and in order to guarantee sufficient stability of the pressure-sensitive adhesive in the adhesively bonded assembly, then, sufficient cohesion on the part of the pressure-sensitive adhesives is required. For good adhesion properties, however, the pressure-sensitive adhesives must also be capable of flowing onto the substrate and guaranteeing sufficient wetting of the substrate surface.

In order to prevent fractures within the bonded joint (within the layer of pressure-sensitive adhesive), furthermore, a certain elasticity on the part of the pressure-sensitive adhesive is required. This requirement becomes significant especially when the substrates to be bonded exhibit different characteristics on temperature exposure, as may be manifested, for example, in different coefficients of thermal expansion. In such a case, adhesive tapes are required that are able to compensate the resultant stresses in the adhesive joint and nevertheless to retain their adhesive properties.

Described in the prior art are adhesive tapes with which fulfilling a profile of requirements of this kind was attempted. WO 2006/027387 A1 for example, relates to a method for producing an adhesive tape with a layer of crosslinked acrylate hotmelt pressure-sensitive adhesive on one or both sides, where a thermal crosslinker is added in the melt to an acrylate copolymer containing primary hydroxyl groups, and the polyacrylate is crosslinked homogeneously following application to a layer in web form.

EP 1 978 069 A1 describes a crosslinker-accelerator system for the thermal crosslinking of polyacrylates, the intention being that crosslinking should take place via epoxide groups. The text is geared essentially to advantages associated with the processing of polyacrylate compositions from the melt.

Appearing increasingly on the radar are applications in which the adhesive joints or sealed parts are exposed to considerable thermal stress over a prolonged time. An ongoing need exists for adhesive tapes which allow durably stable adhesive bonds even under these conditions.

It is an object of the invention, therefore, to provide an adhesive tape which durably joins substrates to one another even under strong and sustained thermal stress when those substrates differ in their characteristics under temperature exposure, and/or which, in the case where a sealing material is used, and even when heat exposure is severe and there is an associated change in the extension of the position at which sealing is to take place, reliably continues to provide sealing at said position.

The object is achieved by means of an adhesive tape which exhibits outstanding elastic properties after long storage at 120°-150° C. The invention accordingly first provides an adhesive tape with a thickness of 150 μm, and is characterized in that after storage at 120-150° C. over 60 to 210 days it has an extendability in machine direction to at least three times its original extent.

An “adhesive tape” means a sheetlike structure that either comprises a carrier material coated on at least one side with pressure-sensitive adhesive, or consists of one or more layers of pressure-sensitive adhesive applied directly to one another (adhesive transfer tape) and that has pressure-sensitively adhesive properties at least on one of its two principal faces. For the purposes of this invention, the general expression “adhesive tape” encompasses all sheetlike structures such as two-dimensionally extended sheets or sheet sections, tapes with extended length and limited width, tape sections, stickers, diecuts and the like. By “pressure-sensitively adhesive” is meant that the adhesive tape in question adheres to the majority of surfaces after application of just gentle pressure, without the need for activation by moistening or warming, for example.

The term “carrier material” here embraces any conceivable layer or structure made up of two or more layers that within the adhesive tape is still coated with at least one pressure-sensitively adhesive layer.

The adhesive tape of the invention, then, may be either a single-layer adhesive tape or else a multi-layer adhesive tape. Adhesive tapes of the invention may be configured, for example, as
single-layer, double-sidedly self-adhesive tapes—known as “transfer tapes”—comprising a single layer of a foamed self-adhesive composition;
single-sidedly self-adhesively furnished adhesive tapes—also called “single-sided adhesive tapes” hereinafter—where the layer of self-adhesive composition is a foamed layer, examples being two-layer systems comprising a foamed self-adhesive composition and a heat-activatable adhesive or a foamed or unfoamed carrier layer;
double-sidedly self-adhesively furnished adhesive tapes—also called “double-sided adhesive tapes” hereinafter—where one, more particularly both, layer(s) of self-adhesive is or are a foamed polymer composition and/or where the carrier layer is a foamed polymer layer;
double-sided adhesive tapes having a heat-activatable adhesive layer on one of the adhesive-tape sides and a layer of self-adhesive composition on the other adhesive tape side, where the carrier layer and/or the layer of self-adhesive composition are/is (a) foamed polymer composition(s);
double-sided adhesive tapes having a heat-activatable adhesive layer on both adhesive-tape sides, where the carrier layer is a foamed polymer composition.

The adhesive tapes of the invention may have a symmetrical or asymmetrical product construction. In one preferred embodiment of the invention, the adhesive tape consists of a viscoelastic, foamed carrier which thus itself has pressure-sensitively adhesive properties. In another embodiment, this carrier is coated on one side directly with a pressure-sensitive adhesive. In alternative embodiments, the carrier is coated on both sides directly with pressure-sensitive adhesive, and the two pressure-sensitive adhesives may be the same or different from one another. In a further embodiment, there is at least one, preferably precisely one, additional layer present between the viscoelastic carrier and the pressure-sensitive adhesive or adhesives. This additional layer may be, for example, a primer layer.

The term “viscoelastic” here is understood in accordance with the definition by Chang in “Handbook of Pressure-Sensitive Adhesives and Products—Fundamentals of pressure sensitivity”, edited by I. Benedek and M. M. Feldstein, 2009, CRC Press, Taylor & Francis Group, chapter 5 therein, especially FIG. 5.7, “Transition-flow region, general purpose PSA”, and FIG. 5.13, “Dahlquist contact criteria”.

The thickness of an adhesive tape of the invention is preferably 20 μm to 8000 μm, more preferably 30 μm to 7000 μm, more particularly 70 μm to 6000 μm, as for example 100 μm to 5500 μm and very preferably 120 μm to 5200 μm. With more particular preference the total thickness of the adhesive tape of the invention is 200 μm to 5500 μm. The thickness of a single-layer adhesive tape of the invention is more preferably 30 μm to 1300 μm, more particularly 200 μm to 1200 μm, and the thickness of a multilayer, more particularly three-layer adhesive tape of the invention is more preferably 80 μm to 8000 μm, more particularly 200 μm to 5500 μm. In accordance with the invention, any release liner present on one or both sides of the adhesive tape does not form part of the adhesive tape and is therefore not taken into account when determining the thickness of the adhesive tape either.

By the “thickness” of the adhesive tape is meant, in accordance with the invention, the extent of the adhesive tape in question along the z-ordinate of an imaginary coordinate system in which the plane extending through the machine direction and the direction transverse to the machine direction forms the x-y plane. In accordance with the invention, the thickness is ascertained through measurement at not less than five different locations of the layer or phase in question, and then by formation of the arithmetic average from the measurement results obtained. The thickness of the adhesive tape of the invention is determined in accordance with ISO 1923.

The adhesive tape of the invention preferably comprises at least one thermally crosslinked polymer. Surprisingly, adhesive tapes based on thermally crosslinked polymers have emerged as being more thermally stable than adhesive tapes based on UV-crosslinked polymers. This is manifested especially in a relatively lower decrease in tensile strength following prolonged exposure to high temperatures, which has even been observed for three-layer products without promoter between core and pressure-sensitive adhesive.

The adhesive tape of the invention preferably comprises at least one foamed layer.

Suitable base polymers for the foamed layer include in principle all thermally crosslinkable and thermoplastically processable polymers known to the skilled person. At least one base polymer of the foamed layer is preferably thermally crosslinkable. By “base polymer” is meant a polymer which is present in a proportion of at least 30 wt %, based on the entirety of the polymers present in the layer in question. With particular preference, at least one base polymer of the foamed layer is selected from the group consisting of poly(meth)acrylates, natural rubber, synthetic rubber, vinylaromatic block copolymers, more particularly styrene block copolymers, ethylene-vinyl acetates (EVA), silicone rubber, polyvinyl ethers, polyurethanes, and mixtures of two or more of the stated polymers. With very particular preference all base polymers of the foamed layer are selected from the group consisting of poly(meth)acrylates, natural rubbers, synthetic rubbers, vinylaromatic block copolymers, more particularly styrene block copolymers, ethylene-vinyl acetates (EVA), silicone rubbers, polyvinyl ethers, polyurethanes, and mixtures of two or more of the stated polymers.

The adhesive tape of the invention preferably comprises at least one pressure-sensitive adhesive layer which comprises at least one polymer selected from the group consisting of poly(meth)acrylates, synthetic rubbers, vinylaromatic block copolymers, more particularly styrene block copolymers, polyolefins and mixtures of two or more of the above polymers. The pressure-sensitive adhesive layer may be identical to the foamed layer, but may also be present as an independent layer in the adhesive tape of the invention.

Very preferably at least one base polymer of the foamed layer is a poly(meth)acrylate. Likewise very preferably the adhesive tape of the invention comprises at least one pressure-sensitive adhesive layer which comprises at least one poly(meth)acrylate. More particularly, all of the base polymers of the foamed layer are poly(meth)acrylates. Likewise more particularly, all pressure-sensitive adhesive layers in the adhesive tape of the invention comprise one or more poly(meth)acrylate(s) as their principal constituent. “Principal constituent” means, in accordance with the invention, that the constituent in question accounts for at least 80 wt % of the layer in question.

By “poly(meth)acrylates” are meant polymers whose monomer basis consists to an extent of at least 60 wt % of acrylic acid, methacrylic acid, acrylic esters and/or methacrylic esters, including acrylic esters and/or methacrylic esters at least proportionally, preferably to an extent of at least 50 wt %, based on the entirety of the monomer basis of the polymer in question. More particularly a “poly(meth)acrylate” means a polymer obtainable by radical polymerization of acrylic and/or methacrylic monomers and also, optionally, further copolymerizable monomers.

The poly(meth)acrylates of the invention are preferably obtainable by at least proportionally copolymerizing functional monomers crosslinkable with epoxide groups. These are, more preferably, monomers having acid groups (especially carboxylic acid, sulfonic acid or phosphonic acid groups) and/or hydroxyl groups and/or acid anhydride groups and/or epoxide groups and/or amide groups; carboxyl group-containing monomers are more particularly preferred. It is especially advantageous if the polyacrylate includes copolymerized acrylic acid and/or methacrylic acid. All of these groups exhibit crosslinkability with epoxide groups, thereby rendering the polyacrylate advantageously amenable to thermal crosslinking with incorporated epoxides.

Further monomers which may be used as comonomers for the poly(meth)acrylates besides acrylic and/or methacrylic esters having up to 30 C atoms are, for example, vinyl esters of carboxylic acids containing up to 20 C atoms, vinylaromatics having up to 20 C atoms, ethylenically unsaturated nitriles, vinyl halides, vinyl ethers of alcohols containing 1 to 10 C atoms, aliphatic hydrocarbons having 2 to 8 C atoms and 1 or 2 double bonds, or mixtures of these monomers.

The properties of the poly(meth)acrylate in question (pressure-sensitive adhesive, heat-sealing composition, viscoelastic non-tacky material and the like) may be influenced in particular by varying the glass transition temperature of the polymer, through different weight fractions of the individual monomers.

For purely crystalline systems there is a thermal equilibrium between crystal and liquid at the melting point Tₘ. Amorphous or semicrystalline systems, in contrast, are characterized by the transformation of the more or less hard amorphous or semicrystalline phase into a softer (rubber-like to viscous) phase. In the case of polymeric systems in particular, at the glass transition point, there is “thawing” (or “freezing-in” in the case of cooling) of the Brownian molecular motion of relatively long chain segments.

The transition from the melting point Tₘ (also “melting temperature”; actually defined only for purely crystalline systems; “polymer crystals”) to the glass transition point T_{g} (also “glass transition temperature” or “glass temperature”) may therefore be considered to be a fluid transition, depending on the fraction of semicrystallinity in the sample under investigation.

For the purposes of this specification, and in line with the observations made above, a statement of the glass transition point also embraces the melting point, and therefore the glass transition point (or else, synonymously, the glass transition temperature) also comprehends the melting point for the corresponding “melting” systems. The reports of the glass transition temperatures refer to the determination by means of dynamic mechanical analysis (DMA) at low frequencies.

In order to obtain polymers, for example pressure-sensitive adhesives or heat-sealing compositions, having desired glass transition temperatures, the quantitative composition of the monomer mixture is preferably selected such as to result, in accordance with an equation (E1) in analogy to the Fox equation (cf. T. G. Fox, Bull. Am. Phys. Soc. 1956, 1, 123), the desired T_{g} for the polymer.

$$\frac{1}{{T}_{g}} = {\sum }_{n} \frac{{w}_{n}}{{T}_{g , n}} \qquad ( E1 )$$

In this equation, n represents the serial number of the monomers used, wₙ the mass fraction of the respective monomer n (wt %) and T_{g,n} the respective glass transition temperature of the homopolymer of each of the monomers n, in K.

The poly(meth)acrylate or poly(meth)acrylate(s) of the invention may be traced back preferably to the following monomer composition:
a) acrylic esters and/or methacrylic esters of the following formula

CH₂═C(R^{I})(COOR^{II})
where R^{I} is H or CH₃ and R^{H} is an alkyl radical having 4 to 14 C atoms,
b) olefinically unsaturated monomers with functional groups of the kind already defined for reactivity with epoxide groups,
c) optionally further acrylates and/or methacrylates and/or olefinically unsaturated monomers, which are copolymerizable with component (a).

For the purpose of employing the polyacrylate as a pressure-sensitive adhesive (PSA), the proportions of the corresponding components (a), (b) and (c) are preferably selected such that the polymerization product has a glass transition temperature ≦15° C. (DMA at low frequencies).

For the preparation of PSAs it is very advantageous in particular to select the monomers of component (a) with a fraction of 45 to 99 wt %, the monomers of component (b) with a fraction of 1 to 15 wt % and the monomers of component (c) with a fraction of 0 to 40 wt % (the figures are based on the monomer composition for the “base polymer”, i.e. without additions of any additives to the complete polymer, such as resins, etc).

If the polyacrylate is to be used as a hotmelt adhesive, in other words as a material which acquires pressure-sensitive adhesion only by heating, the fractions of components (a), (b), and (c) are preferably selected such that the copolymer has a glass transition temperature (T_{g}) of between 15° C. and 100° C., preferably between 30° C. and 80° C., more preferably between 40° C. and 60° C.

A viscoelastic material, which may typically be laminated on both sides with pressure-sensitively adhesive layers, has a glass transition temperature (T_{g}) more particularly of between −50° C. to +100° C., preferably between −20° C. to +60° C., more preferably 0° C. to 40° C. Here again, the fractions of components (a), (b) and (c) are to be selected accordingly.

The monomers of component (a) are, in particular, plasticizing and/or apolar monomers. Employed with preference as monomers (a) are acrylic and methacrylic esters having alkyl groups consisting of 4 to 14 C atoms, more preferably 4 to 9 C atoms. Examples of monomers of this kind are n-butyl acrylate, n-butyl methacrylate, n-pentyl acrylate, n-pentyl methacrylate, n-amyl acrylate, n-hexyl acrylate, n-hexyl methacrylate, n-heptyl acrylate, n-octyl acrylate, n-octyl methacrylate, n-nonyl acrylate, isobutyl acrylate, isooctyl acrylate, isooctyl methacrylate, and their branched isomers, such as 2-ethylhexyl acrylate or 2-ethylhexyl methacrylate, for example.

The monomers of component (b) are, in particular, olefinically unsaturated monomers having functional groups, more particularly having functional groups which are able to enter into a reaction with epoxide groups.

Monomers used for component (b) are preferably monomers having functional groups selected from the group encompassing the following: hydroxyl groups, carboxyl groups, sulfonic acid groups or phosphonic acid groups, acid anhydrides, epoxides, amines.

Particularly preferred examples for monomers of component (b) are acrylic acid, methacrylic acid, itaconic acid, maleic acid, fumaric acid, crotonic acid, aconitic acid, dimethylacrylic acid, β-acryloyloxypropionic acid, trichloroacrylic acid, vinylacetic acid, vinylphosphonic acid, maleic anhydride, hydroxyethyl acrylate, hydroxypropyl acrylate, hydroxyethyl methacrylate, hydroxypropyl methacrylate, 6-hydroxyhexyl methacrylate, allyl alcohol, glycidyl acrylate, glycidyl methacrylate.

As component (c) it is possible in principle to use all vinylically functionalized compounds which are copolymerizable with component (a) and/or with component (b). The monomers of component (c) may serve to adjust the properties of the resultant PSA.

Exemplary monomers of component (c) are:

methyl acrylate, ethyl acrylate, propyl acrylate, methyl methacrylate, ethyl methacrylate, benzyl acrylate, benzyl methacrylate, sec-butyl acrylate, tert-butyl acrylate, phenyl acrylate, phenyl methacrylate, isobornyl acrylate, isobornyl methacrylate, tert-butylphenyl acrylate, tert-butylphenyl methacrylate, dodecyl methacrylate, isodecyl acrylate, lauryl acrylate, n-undecyl acrylate, stearyl acrylate, tridecyl acrylate, behenyl acrylate, cyclohexyl methacrylate, cyclopentyl methacrylate, phenoxyethyl acrylate, phenoxyethyl methacrylate, 2-butoxyethyl methacrylate, 2-butoxyethyl acrylate, 3,3,5-trimethylcyclohexyl acrylate, 3,5-dimethyladamantyl acrylate, 4-cunnylphenyl methacrylate, cyanoethyl acrylate, cyanoethyl methacrylate, 4-biphenylyl acrylate, 4-biphenylyl methacrylate, 2-naphthyl acrylate, 2-naphthyl methacrylate, tetrahydrofufuryl acrylate, diethylaminoethyl acrylate, diethylaminoethyl methacrylate, dimethylaminoethyl acrylate, dimethylaminoethyl methacrylate, 2-butoxyethyl acrylate, 2-butoxyethyl methacrylate, methyl 3-methoxyacrylate, 3-methoxybutyl acrylate, 2-phenoxyethyl methacrylate, butyldiglycol methacrylate, ethylene glycol acrylate, ethylene glycol monomethylacrylate, methoxy polyethylene glycol methacrylate 350, methoxy polyethylene glycol methacrylate 500, propylene glycol monomethacrylate, butoxydiethylene glycol methacrylate, ethoxytriethylene glycol methacrylate, octafluoropentyl acrylate, octafluoropentyl methacrylate, 2,2,2-trifluoroethyl methacrylate, 1,1,1,3,3,3-hexafluoroisopropyl acrylate, 1,1,1,3,3,3-hexafluoro isopropyl methacrylate, 2,2,3,3,3-pentafluoropropyl methacrylate, 2,2,3,4,4,4-hexafluorobutyl methacrylate, 2,2,3,3,4,4,4-heptafluorobutyl acrylate, 2,2,3,3,4,4,4-heptafluorobutyl methacrylate, 2,2,3,3,4,4,5,5,6,6,7,7,8,8,8-pentadecafluorooctyl methacrylate, dimethyl-aminopropylacrylamide, dimethylaminopropylmethacrylamide, N-(1-methylundecyl)acrylamide, N-(n-butoxymethyl)acrylamide, N-(butoxymethyl)methacrylamide, N-(ethoxymethyl)acrylamide, N-(n-octadecyl)acrylamide, and also N,N-dialkyl-substituted amides, such as, for example, N,N-dimethylacrylamide, N,N-dimethylmethacrylamide, N-benzylacrylamides, N-isopropylacrylamide, N-tert-butylacrylamide, N-tert-octylacrylamide, N-methylolacrylamide, N-methylolmethacrylamide, acrylonitrile, methacrylonitrile, vinyl ethers, such as vinyl methyl ether, ethyl vinyl ether, and vinyl isobutyl ether, vinyl esters, such as vinyl acetate, vinyl chloride, vinyl halides, vinylidene chloride, vinylidene halides, vinylpyridine, 4-vinylpyridine, N-vinylphthalimide, N-vinyllactam, N-vinylpyrrolidone, styrene, α- and p-methylstyrene, α-butylstyrene, 4-n-butylstyrene, 4-n-decylstyrene, 3,4-dimethoxystyrene, and macromonomers such as 2-polystyreneethyl methacrylate (molecular weight Mw from 4000 to 13 000 g/mol) and poly(methyl methacrylate)ethyl methacrylate (Mw from 2000 to 8000 g/mol).

Monomers of component (c) may advantageously also be selected to contain functional groups which support subsequent radiation crosslinking (for example by electron beams, UV). Examples of suitable copolymerizable photoinitiators are benzoin acrylate and acrylate-functionalized benzophenone derivatives. Monomers which support crosslinking by electron bombardment are, for example, tetrahydrofurfuryl acrylate, N-tert-butylacrylamide and allyl acrylate.

The preparation of the polyacrylates (“polyacrylates” are understood in the context of the invention to be synonymous with “poly(meth)acrylates”) may take place in accordance with methods familiar to the skilled person, with particular advantage by conventional radical polymerization or controlled radical polymerizations. The polyacrylates may be prepared by copolymerization of the monomeric components, using the customary polymerization initiators and also, optionally, chain transfer agents, with polymerization taking place at the customary temperatures in bulk, in emulsion, for example in water or liquid hydrocarbons, or in solution.

The polyacrylates are prepared preferably by polymerization of the monomers in solvents, more particularly in solvents having a boiling range of 50 to 150° C., preferably of 60 to 120° C., using the customary amounts of polymerization initiators, which are generally 0.01 to 5, more particularly 0.1 to 2 wt % (based on the total weight of the monomers).

Suitable in principle are all customary initiators familiar to the skilled person. Examples of radical sources are peroxides, hydroperoxides and azo compounds, examples being dibenzoyl peroxide, cumene hydroperoxide, cyclohexanone peroxide, di-t-butyl peroxide, cyclohexylsulfonyl acetyl peroxide, diisopropyl percarbonate, t-butyl peroctoate, benzopinacol. One very preferred procedure uses as radical initiator 2,2′-azobis(2-methylbutyronitrile) (Vazo® 67™ from DuPont) or 2,2′-azobis(2-methylpropionitrile) (2,2′-azobisisobutyronitrile; AIBN; Vazo® 64™ from DuPont).

Solvents suitable for preparing the poly(meth)acrylates include alcohols such as methanol, ethanol, n- and isopropanol, n- and isobutanol, preferably isopropanol and/or isobutanol, and also hydrocarbons such as toluene and especially benzines with a boiling range of 60 to 120° C. Furthermore, ketones can be used such as preferably acetone, methyl ethyl ketone, methyl isobutyl ketone and esters such as ethyl acetate, and also mixtures of solvents of the type stated, with preference being given to mixtures comprising isopropanol, more particularly in amounts of 2 to 15 wt %, preferably 3 to 10 wt %, based on the solvent mixture employed.

The preparation (polymerization) of the polyacrylates is followed preferably by concentration, and the further processing of the polyacrylates takes place in substantially solvent-free form. Concentration of the polymer may be accomplished in the absence of crosslinker substances and accelerator substances. It is also possible, however, for one of these classes of compound to be added to the polymer even prior to concentration, and so in that case concentration takes place in the presence of this or these substance(s).

Following the concentration step, the polymers may be transferred to a compounder. An optional possibility is for concentration and compounding to take place in the same reactor.

The weight-average molecular weights M_{W} of the polyacrylates are preferably in a range from 20 000 to 2 000 000 g/mol; very preferably in a range from 100 000 to 1 000 000 g/mol, most preferably in a range from 150 000 to 500 000 g/mol [the figures for average molecular weight M_{W} and polydispersity PD in this specification relate to the figures determined by gel permeation chromatography]. For this purpose it may be advantageous to carry out the polymerization in the presence of suitable chain transfer agents such as thiols, halogen compounds, and/or alcohols, in order to set the desired average molecular weight.

The polyacrylate preferably has a K value of 30 to 90, more preferably of 40 to 70, measured in toluene (1% strength solution, 21° C.). The K value according to Fikentscher is a measure of the molecular weight and the viscosity of the polymer.

Particularly suitable in accordance with the invention are polyacrylates which have a narrow molecular weight distribution (polydispersity PD<4). These compositions, in spite of a relatively low molecular weight, have particularly good shear strength after crosslinking. Moreover, the lower polydispersity enables easier processing from the melt, since the flow viscosity is lower by comparison with a polyacrylate having a broader distribution, while the applications properties are largely the same. Poly(meth)acrylates with a narrow distribution (narrow range) can be prepared advantageously by anionic polymerization or by controlled radical polymerization methods, the latter being especially suitable. Examples of such polyacrylates which can be prepared by the RAFT process are described in U.S. Pat. No. 6,765,078 B2 and U.S. Pat. No. 6,720,399 B2. Corresponding polyacrylates can also be prepared via N-oxyls, as described in EP 1 311 555 B1, for example. Atom Transfer Radical Polymerization (ATRP) as well may be used advantageously for the synthesis of narrow-range polyacrylates, the initiator used comprising preferably monofunctional or difunctional secondary or tertiary halides, and abstraction of the halide or halides being carried out using complexes of Cu, Ni, Fe, Pd, Pt, Ru, Os, Rh, Co, Ir, Ag or Au. The various possibilities of ATRP are described in specifications U.S. Pat. No. 5,945,491 A, U.S. Pat. No. 5,854,364 A and U.S. Pat. No. 5,789,487 A.

The monomers for preparing the poly(meth)acrylates preferably include a proportion of functional groups suitable for entering into linking reactions with epoxide groups. This has the advantageous effect of enabling thermal crosslinking of the polyacrylates by reaction with epoxides. Linking reactions are understood in particular as addition reactions and substitution reactions. Preferably, therefore, there is a linking of the building blocks carrying the functional groups to building blocks carrying epoxide groups, especially in the sense of a crosslinking of the polymer building blocks that carry the functional groups, via crosslinker molecules carrying epoxide groups, as linking bridges. The substances containing epoxide groups are preferably polyfunctional epoxides, these being epoxides having at least two epoxide groups; accordingly, there is preferably overall an indirect linking of the building blocks carrying the functional groups.

The poly(meth)acrylates preferred in accordance with the invention can be used advantageously especially when the requirement is for a high coatweight in one layer, since with appropriate coating procedures an almost arbitrarily high coatweight, preferably of more than 100 g/m², more preferably of more than 200 g/m², is possible, in particular with homogeneous crosslinking right through the layer at the same time.

The poly(meth)acrylates preferred in accordance with the invention may also form the basis for the PSA of a carrier-less adhesive tape, referred to as an adhesive transfer tape. Here as well, the possibility of setting an almost arbitrarily high coatweight in conjunction with homogeneous crosslinking right through the layer is a particular advantage. Preferred weights per unit area are more than 10 g/m² to 5000 g/m², more preferably 100 g/m² to 3000 g/m².

In accordance with the invention, it is also possible for the adhesive tape of the invention to comprise one or more polyacrylates, more particularly one or more thermally crosslinkable polyacrylates, admixed (blended) with one or more other polymers, as principal constituent of a layer, more particularly of a foamed layer. Suitable for this purpose are the following options already cited as preferred base polymers of the foamed layer besides polyacrylates: natural rubbers, synthetic rubbers, vinylaromatic block copolymers, more particularly styrene block copolymers, EVA, silicone rubbers, polyvinyl ethers and polyurethanes. It has proved to be useful to add these polymers in granulated or otherwise comminuted form to the polyacrylate, preferably before the possible addition of a thermal crosslinker. The polymer blends are preferably produced in an extruder, more particularly in a multi-screw extruder or in a planetary roller mixer. For stabilizing thermally crosslinked acrylate hotmelts, including, in particular, polymer blends of thermally crosslinked acrylate hotmelts and other polymers, it may be useful to irradiate the shaped material with low-dose electron bombardment. For this purpose, it is possible optionally to add crosslinking promoters to the polyacrylate, such as di-, tri-, or polyfunctional acrylates, polyesters and/or urethane acrylates.

In one advantageous embodiment of the invention, the adhesive tape has at least one foamed layer and a pressure-sensitive adhesive layer laminated onto the foamed layer. The pressure-sensitive adhesive layer laminated onto the foamed layer preferably comprises at least one poly(meth)acrylate as principal constituent.

Preferably at least one of the layers (foam or PSA), more preferably both layers, have been pre-treated by corona (with air or nitrogen), plasma (air, nitrogen or other reactive gases or reactive compounds employable as aerosols) or flame pre-treatment methods.

An alternative possibility is for different or differently pre-treated adhesive layers to be laminated to the foamed layer—these layers being, for example, pressure-sensitive adhesive layers and/or heat-activatable layers based on polymers other than poly(meth)acrylates. Suitable base polymers are natural rubbers, synthetic rubbers, acrylate block copolymers, vinylaromatic block copolymers, more particularly styrene block copolymers, EVA, polyolefins, polyurethanes, polyvinyl ethers and silicones. These layers preferably contain no significant proportions of migratable constituents, whose compatibility with the material of the foamed layer is such that they diffuse in significant quantity into the foamed layer and alter the properties there.

Instead of laminating a pressure-sensitive adhesive layer onto the foamed layer on both sides, it is also possible for a hotmelt adhesive layer or thermally activatable adhesive layer to be laminated onto at least one side. The asymmetric adhesive tapes obtained in this way allow the bonding of critical substrates with a high bonding strength. An adhesive tape of this kind may be used, for example, for affixing EPDM rubber profiles on vehicles.

Not only foamed layers but also—unless identical therewith in any case—pressure-sensitive adhesive layers of the adhesive tape of the invention may comprise at least one tackifying resin. Where the product construction of the adhesive tape of the invention envisages both a foamed layer and outer layers of pressure-sensitive adhesive, and where these layers contain the same base polymers, it is advantageous to use the same resins in the same concentration in all of these layers, in order to prevent changes in product properties as a result of resin migration between the layers. Where these layers do not contain the same base polymer or polymers, it is advantageous to select the resins in such a way that they are incompatible with the respective other layer in the sense that they do not migrate into it and hence do not give rise to any changes in properties.

Tackifying resins which can be used are, in particular, aliphatic, aromatic and/or alkylaromatic hydrocarbon resins, hydrocarbon resins based on pure monomers, hydrogenated hydrocarbon resins, functional hydrocarbon resins, and natural resins. The tackifying resin is preferably selected from a group encompassing pinene resins, indene resins and rosins, their disproportionated, hydrogenated, polymerized and/or esterified derivatives and salts, terpene resins and terpene-phenolic resins, and also C5, C9 and other hydrocarbon resins. Combinations of these and further resins may also be employed advantageously in order to adjust the properties of the resultant adhesive in accordance with requirements. The tackifying resin is selected with particular preference from the group encompassing terpene-phenolic resins and rosin esters.

In one specific embodiment, the adhesive tape of the invention comprises a foamed layer which comprises at least one poly(meth)acrylate as principal constituent, and at least one outer pressure-sensitive adhesive layer which comprises at least one vinylaromatic block copolymer as principal constituent. In this case in the outer pressure-sensitive adhesive layer it is possible not only to use the aforementioned resins but also further tackifier resins in order to increase the adhesion. The tackifier resin or resins ought to be compatible with the elastomer block (soft block) of the block copolymers. Preferred tackifier resins of this embodiment of the invention are selected from the group encompassing unhydrogenated, partly hydrogenated and fully hydrogenated resins based on rosin or rosin derivatives, hydrogenated polymers of dicyclopentadiene, unhydrogenated, partially, selectively and fully hydrogenated hydrocarbon resins based on C5, C5/C9 or C9 monomer streams, polyterpene resins based on α-pinene and/or β-pinene and/or δ-limonene, and also mixtures of the resins cited here, the tackifier resins being incompatible with the acrylate polymer of the foamed layer. Particularly preferred are polyterpene resins based on α-pinene and/or β-pinene and/or δ-limonene and also mixtures thereof. The formulation of the adhesive may also comprise tackifier resins which are liquid at room temperature.

The polymers used in the adhesive tape according to the invention, especially the poly(meth)acrylates, are preferably crosslinked by linking reactions—especially in the sense of addition reactions or substitution reactions—of functional groups present therein using thermal crosslinkers. All thermal crosslinkers can be used that have not only a sufficiently long processing life—so that there is no gelling during the processing operation, more particularly the extrusion operation—and rapid aftercrosslinking of the polymer to the desired degree of crosslinking at temperatures lower than the processing temperature, more particularly at room temperature. Possible, for example, is a combination of carboxyl-, amino- and/or hydroxyl group-containing polymers and isocyanates as crosslinkers, especially the aliphatic or amine-deactivated trimerized isocyanates described in EP 1 791 922 A1.

Suitable isocyanates are, in particular trimerized derivatives of MDI [4,4-methylenedi(phenyl isocyanate)], HDI [hexamethylene diisocyanate, 1,6-hexylene diisocyanate] and/or IPDI [isophorone diisocyanate, 5-isocyanato-1-isocyanatomethyl-1,3,3-trimethylcyclohexane], examples being the products Desmodur® N3600 and XP2410 (each BAYER AG: aliphatic polyisocyanates, low-viscosity HDI trimers). Likewise suitable is the surface-deactivated dispersion of micronized trimerized IPDI BUEJ 339®, now HF9® (BAYER AG).

Also suitable in principle for crosslinking, however, are other isocyanates such as Desmodur VL 50 (MDI-based polyisocyanates, Bayer AG), Basonat F200WD (aliphatic polyisocyanate, BASF AG), Basonat HW100 (water-emulsifiable polyfunctional isocyanate based on HDI, BASF AG), Basonat HA 300 (allophanate-modified polyisocyanate based on HDI isocyanurate, BASF) or Bayhydur VPLS2150/1 (hydrophilically modified IPDI, Bayer AG).

The thermal crosslinker, for example the trimerized isocyanate, is used preferably at 0.1 to 5 wt %, more particularly 0.2 to 1 wt %, based on the total amount of the polymer to be crosslinked.

The adhesive tape of the invention preferably comprises at least one epoxide-crosslinked polymer, more preferably at least one poly(meth)acrylate crosslinked by means of at least one substance containing epoxide groups. More particularly, all base polymers in the pressure-sensitive adhesive layers and/or foamed layers present in the adhesive tape of the invention are polymers crosslinked by means of at least one substance containing epoxide groups. Very preferably, all base polymers in the pressure-sensitive adhesive layers and/or foamed layers present in the adhesive tape of the invention are poly(meth)acrylates crosslinked by means of at least one substance containing epoxide groups.

The substances containing epoxide groups are more particularly polyfunctional epoxides, in other words those having at least two epoxide groups, and accordingly the overall result is an indirect linking of the building blocks that carry the functional groups. The substances containing epoxide groups may be both aromatic compounds and aliphatic compounds.

Outstandingly suitable polyfunctional epoxides are oligomers of epichlorohydrin, epoxy ethers of polyhydric alcohols (especially ethylene, propylene, and butylene glycols, polyglycols, thiodiglycols, glycerol, pentaerythritol, sorbitol, polyvinyl alcohol, polyallyl alcohol and the like), epoxy ethers of polyhydric phenols [in particular resorcinol, hydroquinone, bis(4-hydroxyphenyl)methane, bis(4-hydroxy-3-methylphenyl)methane, bis(4-hydroxy-3,5-dibromophenyl)methane, bis(4-hydroxy-3,5-difluorophenyl)methane, 1,1-bis(4-hydroxyphenyl)ethane, 2,2-bis(4-hydroxyphenyl)propane, 2,2-bis(4-hydroxy-3-methylphenyl)propane, 2,2-bis(4-hydroxy-3-chlorophenyl)propane, 2,2-bis(4-hydroxy-3,5-dichlorophenyl)propane, 2,2-bis(4-hydroxy-3,5-dichlorophenyl)propane, bis(4-hydroxy-phenyl)phenylmethane, bis(4-hydroxyphenyl)phenylmethane, bis(4-hydroxyphenyl)diphenylmethane, bis(4-hydroxyphenyl)-4′-methylphenylmethane, 1,1-bis(4-hydroxy-phenyl)-2,2,2-trichloroethane, bis(4-hydroxyphenyl)-(4-chlorophenyl)methane, 1, 1-bis(4-hydroxyphenyl)cyclohexane, bis(4-hydroxyphenyl)cyclohexylmethane, 4,4-dihydroxybiphenyl, 2,2′-dihydroxybiphenyl, 4,4′-dihydroxydiphenyl sulfone] and also their hydroxyethyl ethers, phenol-formaldehyde condensation products, such as phenol alcohols, phenol aldehyde resins and the like, S- and N-containing epoxides (for example N,N-diglycidylaniline, N,N′-dimethyldiglycidyl-4,4-diaminodiphenylmethane) and also epoxides, prepared by customary methods from polyunsaturated carboxylic acids or from monounsaturated carboxylic acid esters of unsaturated alcohols, glycidyl esters, polyglycidyl esters obtainable by polymerizing or copolymerizing glycidyl esters of unsaturated acids, or are obtainable from other acidic compounds (cyanuric acid, diglycidyl sulphide, cyclic trimethylene trisulphone and/or derivatives thereof, etcetera).

Very suitable ethers are, for example, 1,4-butanediol diglycidyl ether, polyglycerol-3 glycidyl ether, cyclohexanedimethanol diglycidyl ether, glycerol triglycidyl ether, neopentylglycol diglycidyl ether, pentaerythritol tetraglycidyl ether, 1,6-hexanediol diglycidyl ether, polypropylene glycol diglycidyl ether, trimethylolpropane triglycidyl ether, bisphenol A diglycidyl ether and bisphenol F diglycidyl ether.

Particularly preferred, especially for poly(meth)acrylates as polymers to be crosslinked, is the use of a crosslinker-accelerator system described, for example in EP 1 978 069 A1 (“crosslinking system”), in order to obtain better control over the processing life, crosslinking kinetics and degree of crosslinking. The crosslinker-accelerator system comprises at least one substance containing epoxide groups, as crosslinker, and as accelerator at least one substance which has an accelerating effect for crosslinking reactions by means of compounds containing epoxide groups at a temperature below the melting temperature of the polymer to be crosslinked.

Accelerators used with particular preference are amines (to be interpreted formally as substitution products of ammonia; in the following formulae, these substituents are represented by “R” and encompass, in particular, alkyl radicals and/or aryl radicals and/or other organic radicals), more preferably those amines which enter into minimal or no reactions with the building blocks of the polymers to be crosslinked.

Crosslinkers selectable include in principle primary (NRH₂), secondary (NR₂H) and tertiary (NR₃) amines, of course including those which have a plurality of primary and/or secondary and/or tertiary amine groups. Particularly preferred accelerators, however, are tertiary amines such as, for example, triethylamine, triethylenediamine, benzyldimethylamine, dimethylaminomethylphenol, 2,4,6-tris(N,N-dimethylaminomethyl)phenol, and N,N′-bis(3-(dimethylamino)propyl)urea. Also possible for advantageous use as accelerators are polyfunctional amines such as diamines, triamines and/or tetramines. Outstanding suitability is possessed for example by diethylenetriamine, triethylenetetramine and trimethylhexamethylenediamine.

Amino alcohols are preferably used, furthermore, as accelerators. Particularly preference is given to using secondary and/or tertiary amino alcohols, and in the case of a plurality of amine functionalities per molecule it is preferred for at least one and preferably all the amine functionalities to be secondary and/or tertiary. Preferred amino alcohol accelerators used may be triethanolamine, N,N-bis(2-hydroxypropyl)ethanolamine, N-methyldiethanolamine, N-ethyldiethanolamine, 2-aminocyclohexanol, bis(2-hydroxycyclohexyl)methylamine, 2-(diisopropylamino)ethanol, 2-(dibutylamino)ethanol, N-butyldiethanolamine, N-butylethanolamine, 2-[bis(2-hydroxyethyl)amino]-2-(hydroxymethyl)-1,3-propanediol, 1-[bis(2-hydroxyethypamino]-2-propanol, triisopropanolamine, 2-(dimethylamino)ethanol, 2-(diethylamino)ethanol, 2-(2-dimethylaminoethoxy)ethanol, N,N,N′-trimethyl-N′-hydroxyethylbisaminoethyl ether, N,N,N′-trimethylaminoethylethanolannine and/or N,N,N′-trimethylaminopropylethanolannine.

Other suitable accelerators are pyridine, imidazoles (such as 2-methylimidazole for example) and 1,8-diazabicyclo[5.4.0]undec-7-ene. Cycloaliphatic polyamines as well can be used as accelerators. Also suitable are phosphate-based accelerators such as phosphines and/or phosphonium compounds, such as triphenylphosphine or tetraphenylphosphonium tetraphenylborate, for example.

The adhesive tape of the invention may comprise one or more fillers. The filler or fillers may be present in one or in a plurality of layers of the adhesive tape.

Thus an adhesive tape of the invention preferably comprises a foamed layer which comprises partly or fully expanded microballoons. Microballoons are hollow elastic beads which have a thermoplastic polymer shell; hence they are also referred to as expandable polymeric microspheres or as hollow microbeads. These beads are filled with low-boiling liquids or liquefied gas. Shell material used includes in particular polyacrylonitrile, polyvinyl dichloride (PVDC), polyvinyl chloride (PVC), polyamides or polyacrylates. Suitable low-boiling liquids are, in particular, lower alkanes, such as isobutane or isopentane, for example, which are included as a liquefied gas under pressure in the polymer shell. By physical action on the microballoons, as for example by exposure to heat—more particularly by supply of heat or generation of heat, induced for example by ultrasound or microwave radiation—the outer polymer shell softens and at the same time the liquid blowing gas present in the shell undergoes the transition into its gaseous state. With a defined pairing of pressure and temperature—referred to as critical pairing for the purposes of this specification—the microballoons undergo an irreversible and three-dimensional expansion. The expansion is at an end when the internal pressure is balanced by the external pressure. Since the polymeric shell is conserved, the result is a closed-cell foam.

A multiplicity of types of microballoon are available commercially, such as, for example, from Akzo Nobel, the Expancel DU (dry unexpanded) products, which differ essentially in their size (6 to 45 μm diameter in the unexpanded state) and their required expansion onset temperature (75° C. to 220° C.).

Furthermore, unexpanded microballoon products are also available as aqueous dispersions with a solids fraction or microballoon fraction of around 40 to 45 wt %, and additionally in the form of polymer-bound microballoons (masterbatches), for example in ethyl vinyl acetate with a microballoon concentration of around 65 wt %. Also available are what are called microballoon slurry systems, in which the microballoons are present in the form of an aqueous dispersion with a solids fraction of 60 to 80 wt %. The microballoon dispersions, the microballoon slurries, and the masterbatches, like the DU products, are all suitable for the foaming of the composition used for a foamed layer of the adhesive tape of the invention.

The foamed layer with particular preference comprises microballoons which in the unexpanded state at 25° C. have a diameter of 3 μm to 40 μm, more particularly of 5 μm to 20 μm, and/or after expansion have a diameter of 10 μm to 200 μm, more particularly of 15 μm to 90 μm.

Its flexible, thermoplastic polymer shell gives a layer thus foamed—in the adhesive tape of the invention comprising such a layer—a higher crack-bridging capacity than a foam filled with unexpandable, non-polymeric hollow microbeads such as hollow glass or ceramic beads. Single-layer, foamed adhesive tapes of the invention, in particular, are therefore very suitable for the compensation of manufacturing tolerances, of the kind which occur with injection-moulded components, for example. Furthermore, such a foam is better able to compensate thermal stresses.

Through the selection of the thermoplastic resin of the polymer shell it is possible to exert further influence over the mechanical properties of the foam. Thus, for example, it is possible to produce foams with higher cohesive strength than with the polymer matrix alone, despite the foam having a lower density than the matrix. Moreover, typical foam properties such as the capacity to conform to rough substrates can be combined with a high cohesive strength for PSA foams.

The foamed layer preferably comprises up to 30 wt % of microballoons, more particularly between 0.5 wt % and 10 wt %, based in each case on the overall mass of the foamed layer.

The adhesive tapes of the invention comprising a foamed layer are preferably characterized by the large-scale absence of open-cell cavities, more particularly of air inclusions, in the foamed layer or layers. With particular preference the foamed layer has a fraction of cavities without their own polymer shell, in other words, a fraction of open-cell caverns, of not more than 2 vol %, more particularly not more than 0.5 vol %. The foamed layer therefore consists preferably of a closed-cell foam. The foamed layer further consists preferably of a syntactic foam.

The adhesive tape of the invention may optionally also comprise powderous and/or granular fillers, dyes and pigments, including more particularly abrasive and reinforcing fillers such as, for example, chalks (CaCO₃), titanium dioxides, zinc oxides and carbon black, in fractions of 0.1 to 15 wt %, based on the overall mass of the adhesive tape. It is very preferred to use different forms of chalk as filler, with particular preference being given to use of Mikrosöhl chalk. In the case of preferred fractions of the fillers of up to 10 wt %, based on the overall mass of the adhesive tape, there is virtually no change in the technical adhesive properties (shear strength at RT, instantaneous bond strength to steel and PE) as a result of the addition of filler.

Additionally there may be low-flammability fillers such as, for example, ammonium polyphosphate; electrically conductive fillers, such as, for example, conductive carbon black, carbon fibres and/or silver-coated beads; thermally conductive materials such as, for example, boron nitride, aluminium oxide, silicon carbide; ferromagnetic additives such as, for example, iron(III) oxides; other additives for increasing volume, more particularly for producing foamed layers or syntactic foams, such as, for example, expandants, solid glass beads, hollow glass beads, carbonized microbeads, phenolic hollow microbeads, microbeads made of other materials; silica, silicates, organically renewable raw materials such as wood flour, for example, organic and/or inorganic nanoparticles, fibres; ageing inhibitors, light stabilizers, ozone protectants and/or compounding agents present in the adhesive tape of the invention. Ageing inhibitors which can be used with preference include not only primary ageing inhibitors, such as 4-methoxyphenol or Irganox® 1076, but also secondary ageing inhibitors, such as Irgafos® TNPP or Irgafos® 168 from BASF, optionally also in combination with one another. Further ageing inhibitors that can be used include phenothiazine (C-radical scavenger) and also hydroquinone methyl ether in the presence of oxygen, and also oxygen itself.

The adhesive tape of the invention may be covered on one or both sides by a release liner, also referred to below for short as “liner”, for the purpose of protecting the surface of the adhesive during transport or during storage. The liner preferably comprises a polyolefin, but may also have additional polymers or polymer layers which contribute to improving the temperature stability, the conformity and/or the deformability. Deformability is especially important in the case of round bonds where the liner is not yet to be removed.

The release liner is more preferably a temperature-stable release liner. This means that the liner withstands processing temperatures of up to 170° C. without substantial restriction of its applications properties.

More particular preference is given to a liner consisting of three layers, the middle layer comprising at least one polyolefin and the two outer layers comprising an LDPE (low-density polyethylene), more particularly an LDPE and an olefinic elastomer. Olefinic elastomers suitable with preference are ethylene-α-olefin copolymers having a density of less than 900 kg/m³.

The liner may further comprise layers comprising PVC, PET, glassine (paper with a polyvinyl alcohol coating), HDPE (high-density polyethylene) and paper. Unless it already has release properties, the base material of the liner may be coated with an additional coat, of silicone, for example.

The liner preferably has a thickness of 127 μm to 254 μm.

The adhesive tapes of the invention, more particularly as transfer tapes or three-layer adhesive tapes, can be employed in a multiplicity of applications, as for example in the construction industry, in the electronics industry, for example in screen bonds, in the DIY sector, in the automotive industry, in ship, boat and railway construction, for household appliances, furniture and the like. Advantageous applications are, for example, the bonding of strips and badges in the aforementioned sectors, the bonding of stiffening profiles for lifts, the bonding of components and products in the solar industry, frame bonding for electronic consumer goods, such as televisions and the like, exterior bonds on cars (bumpers, for example) and also bonds in the production of signs.

In the construction sector, for example, applications as insulating tapes, anti-corrosion tapes, aluminium adhesive tapes, special-purpose adhesive construction tapes, for example vapour barriers and adhesive assembly tapes, are of importance.

Further provided by the invention is a device which comprises a component bonded on one side with a double-sided adhesive tape of the invention, and a heat-resistant release liner applied to the side of the adhesive tape that is not joined to the component.

### EXAMPLES

Unless specifically indicated otherwise or apparent, data for values are subject to standard conditions (25° C., 101325 Pa). Furthermore, sample preparations and measurements described below in accordance with the methods below, in the absence of any indication to the contrary, shall be considered to have been carried out under standard conditions (25° C., 101325 Pa).

Test Methods

Dynamic Shearing Force:

Two steel plates were cleaned with acetone. In the case of the experiments marked “mP”, a lint-free cloth was used to apply, to one side in each case, a thin layer of the primer 60150 from tesa. The double-sided adhesive tape under test (sample size=25×25 mm) was then bonded without bubbles between the—possibly primer-coated—sides of the steel plates, and pressed at 0.1 kN/cm² for 1 minute. The specimens were stored at the respectively indicated temperatures for the respectively indicated time, and then brought to room temperature. For testing, the respective specimen was pulled apart at a rate of 50 mm/min in the machine direction of the adhesive tape, and the maximum force and the elongation measured in the course of this operation were recorded as the result.

Static Glass Transition Temperature Tg:

The static glass transition temperature is determined via dynamic scanning calorimetry in accordance with DIN 53765. The figures for the glass transition temperature Tg relate to the glass transformation temperature value Tg in accordance with DIN 53765:1994-03, unless specifically indicated otherwise.

Molecular Weights:

The average molecular weight M_{W} and the polydispersity D were determined by means of gel permeation chromatography (GPC). The eluent used was THF with 0.1 vol % of trifluoroacetic acid. Measurement took place at 25° C. The preliminary column used was PSS-SDV, 5 μm, 103 Å (10⁻⁷ m), ID 8.0 mm×50 mm. Separation was carried out using the columns PSS-SDV, 5 μm, 103 Å (10⁻⁷ m), 105 Å (10⁻⁵ m) and 106 Å (10⁻⁴ m) each with ID 8.0 mm×300 mm. The sample concentration was 4 g/l, the flow rate 1.0 ml per minute. Measurement took place against PMMA standards.

K Value (According to Fikentscher):

The K value is a measure of the average molecular size of high-polymer materials. It was measured by preparing one percent strength (1 g/100 ml) toluenic polymer solutions and determining their kinematic viscosities with the aid of a Vogel-Ossag viscometer. Standardization to the viscosity of toluene gives the relative viscosity, from which the K value can be calculated according to Fikentscher (Polymer 1967, 8, 381 ff.).

Solids Content:

The solids content is a measure of the fraction of unvaporizable constituents in a polymer solution. It is determined gravimetrically by weighing the solution, then evaporating the vaporizable fractions in a drying cabinet at 120° C. for 2 hours, and re-weighing the residue.

### EXAMPLES

Preparation of Base Polymer Ac1:

A reactor conventional for radical polymerizations was charged with 72.0 kg of 2-ethylhexyl acrylate, 20.0 kg of methyl acrylate, 8.0 kg of acrylic acid and 66.6 kg of acetone/isopropanol (94:6). After nitrogen gas had been passed through the reactor for 45 minutes with stirring, the reactor was heated to 58° C. and 50 g of AIBN, in solution in 500 g of acetone, were added. The external heating bath was then heated to 75° C. and the reaction was carried out constantly at this external temperature. After 1 h a further 50 g of AIBN, in solution in 500 g of acetone, were added, and after 4 hours the batch was diluted with 10 kg of acetone/isopropanol mixture (94:6).

After 5 hours and again after 7 hours, 150 g portions of bis(4-tert-butylcyclohexyl)peroxydicarbonate, in each case in solution in 500 g of acetone, were added for reinitiation. After a reaction time of 22 hours the polymerization was discontinued and the batch was cooled to room temperature. The product had a solids content of 55.8% and was dried. The resulting polyacrylate had a K value of 58.9, an average molecular weight of Mw=748 000 g/mol, a polydispersity of D (Mw/Mn)=8.9 and a static glass transition temperature of Tg=−35.2° C.

Preparation of Base Polymer Ac2:

A reactor conventional for radical polymerizations was charged with 32.0 kg of 2-ethylhexyl acrylate, 64.5 kg of butyl acrylate, 3.5 kg of acrylic acid and 66.7 kg of acetone/isopropanol (96:4). After nitrogen gas had been passed through the reactor for 45 minutes with stirring, the reactor was heated to 58° C. and 50 g of Vazo 67, in solution in 500 g of acetone, were added. The external heating bath was then heated to 70° C. and the reaction was carried out constantly at this external temperature. After 1 h a further 50 g of Vazo 67, in solution in 500 g of acetone, were added, and after 2 hours the batch was diluted with 10 kg of acetone/isopropanol mixture (96:4). After 5.5 hours, 150 g of bis(4-tert-butylcyclohexyl)peroxydicarbonate, in solution in 500 g of acetone, were added; after 6 hours 30 minutes, dilution was carried out again with 10 kg of acetone/isopropanol mixture (96:4). After 7 hours a further 150 g of bis(4-tert-butylcyclohexyl)peroxydicarbonate, in solution in 500 g of acetone, were added, and the heating bath was set to a temperature of 60° C.

After a reaction time of 22 hours the polymerization was discontinued and the batch was cooled to room temperature. The product had a solids content of 50.2% and was dried. The resulting polyacrylate had a K value of 74.9, an average molecular weight of Mw=1 368 000 g/mol, a polydispersity of D (Mw/Mn)=17.11 and a static glass transition temperature of Tg=−37.4° C.

Pressure-Sensitive Polyacrylate Adhesive Ac-PSA:

A 200 l glass reactor conventional for radical polymerizations was charged with 9.6 kg of acrylic acid, 20.0 kg of butyl acrylate, 50.4 kg of 2-ethylhexyl acrylate and 53.4 kg of acetone/benzine 60/95 (1:1). After nitrogen gas had been passed through the reactor for 45 minutes with stirring, the reactor was heated to 58° C. and 60 g of AIBN were added. The external heating bath was then heated to 75° C. and the reaction was carried out constantly at this external temperature. After a reaction time of 1 hour a further 60 g of AIBN were added. After 4 hours and again after 8 hours, dilution took place with 20.0 kg portions of acetone/benzine 60/95 (1:1) mixture. To reduce the residual initiators, 180g portions of bis(4-tert-butylcyclohexyl)peroxydicarbonate were added after 8 hours and again after 10 hours. After a reaction time of 24 hours, the reaction was discontinued and the batch was cooled to room temperature. The polyacrylate was then blended with 0.2 wt % of Uvacure® 1500, diluted to a solids content of 30% with acetone, and then coated from solution onto a siliconized release film (50 μm polyester) or onto a 23 μm etched PET film. (Coating speed 2.5 m/min, drying tunnel 15 m, temperatures zone 1: 40° C., zone 2: 70° C., zone 3: 95° C., zone 4: 105° C.). The coat weight was 50 g/m².

Production of Microballoon Mixtures:

The microballoons are introduced into a container into which a carbon black/water dispersion has been previously introduced. Stirring takes place in a planetary stirrer from pc-Laborsystem, at a pressure of 5 mbar and at a rotary speed of 600 rpm, for 30 minutes.

Method 1: Concentration/Production of PSAs:

The acrylate copolymers (base polymers Ac1 and Ac2) were very largely freed from the solvent using a single-screw extruder (concentrating extruder, Berstorff GmbH, Germany). Shown by way of example here are the parameters for the concentration of the base polymer Ac1. The rotary speed of the screw was 150 rpm, the motor current 15 A, and a throughput of 58.0 kg liquid/h was realized. For the purpose of concentration, reduced pressure was applied at three different domes. The underpressures were in each case between 20 mbar and 300 mbar. The exit temperature of the concentrated polymer is approximately 115° C. The solids content after this concentration step was 99.8%. The composition Ac1 was shaped to a web by means of a roll calender.

Production of Foamed Composition:

The concentrated base polymer Ac2 was melted in a feeder-extruder (single-screw conveying extruder from Troester GmbH & Co KG, Germany) and with this as a polymer melt was conveyed via a heatable hose into a planetary roller extruder from Entex (Bochum) (more particularly a PRE with four modules heatable independently of one another, T₁, T₂, T₃ and T₄, was used). The melted resin was then added via a metering port. A further possibility is to supply additional additives or fillers, such as colorant pastes, for example, via further metering points that are present. The crosslinker was added, and all of the components were mixed to form a homogeneous polymer melt.

Using a melt pump and a heatable hose, the polymer melt was transferred to a twin-screw extruder (from Berstorff), and the accelerator component was added. The overall mixture was then freed from all of the gas inclusions (criterion for freedom from gas: see above) in a vacuum dome under a pressure of 175 mbar. Downstream of the vacuum zone, on the screw, was a blister which allowed the development of pressure in the subsequent segment. Through appropriate control of the extruder speed and the melt pump, a pressure of greater than 8 bar was developed in the segment between blister and melt pump, and the microballoon mixture (microballoons embedded into the dispersing assistant) was added at a further metering point 35, and incorporated homogeneously into the premix by means of a mixing element. The resulting melt mixture was transferred into a die.

Following departure from the die, in other words after a drop in pressure, the incorporated microballoons underwent an expansion, and the pressure drop produced low-shear and more particularly shear-free cooling of the polymer composition. The product was a foamed self-adhesive composition which was subsequently shaped to web form by means of a roll calender.

Production of Double-Sided Adhesive Tapes:

A layer of the polyacrylate PSA (Ac-PSA, 50 μm coat thickness) was laminated onto each of the top and bottom sides of the self-adhesive compositions obtained from Ac1 and Ac2, respectively, and shaped to form a web, with the faces that come into contact with one another having been corona-treated beforehand. The double-sided adhesive tapes obtained were used as the basis for determining, as described above, the maximum dynamic shearing force and the maximum elongation after storage.

In the comparative experiments, adhesive tapes of the prior art were used.

The results are set out in table 1.

TABLE 1
Test results

| | | | | Dynamic | Elongation |
|---|---|---|---|---|---|
| | | Storage | Temp- | shearing | (to % |
| Example | Layer | time | erature | force | of initial |
| No. | construction | (days) | (° C.) | (N/cm²) | length) |
| 1 | Ac-PSA/ | 60 | 120 | 64.2 | 339.6 |
| | Ac1 (900 μm)/ | 98 | 120 | 111.5 | 382.3 |
| | Ac-PSA | 154 | 120 | 133.2 | 366.3 |
| | | 212 | 120 | 156.6 | 365.5 |
| 2 | Ac-PSA/ | 60 | 120 | 75.3 | 374.9 |
| | Ac1 (900 μm)/ | 98 | 120 | 120.0 | 407.5 |
| | Ac-PSA | 154 | 120 | 178.8 | 440.6 |
| | (mP) | 210 | 120 | 178.4 | 415.5 |
| | | 154 | 150 | 212.7 | 346.0 |
| 3 | Ac-PSA/ | 60 | 120 | 57.3 | 350.3 |
| | Ac2 foamed | 98 | 120 | 63.9 | 349.1 |
| | (900 μm)/ | 154 | 120 | 71.1 | 345.4 |
| | Ac-PSA | 210 | 120 | 70.2 | 330.9 |
| | | 210 | 150 | 38.2 | 318.7 |
| 4 | Ac-PSA/ | 60 | 120 | 58.7 | 351.4 |
| | Ac2 foamed | 98 | 120 | 62.9 | 344.7 |
| | (900 μm)/ | 154 | 120 | 70.7 | 339.2 |
| | Ac-PSA (mP) | 210 | 120 | 71.0 | 328.2 |
| | | 210 | 150 | 36.1 | 302.2 |
| 5 (Comp.) | Single-layer, | 60 | 120 | 120.3 | 191.7 |
| | unfoamed | 98 | 120 | 146.4 | 219.4 |
| | polyacrylate | 154 | 120 | 170.6 | 230.1 |
| | adhesive tape, | 60 | 150 | 137.9 | 180.1 |
| | (3M ™ VHB ™ | 98 | 150 | 125.7 | 144.5 |
| | 4910) | | | | |
| 6 (Comp.) | Single-layer, | 60 | 120 | 152.4 | 199.8 |
| | unfoamed | 98 | 120 | 168.3 | 251.4 |
| | polyacrylate | 154 | 120 | 141.6 | 170.2 |
| | adhesive tape, | 210 | 120 | 201.3 | 262.6 |
| | (3M ™ VHB ™ | 60 | 150 | 122.3 | 131.5 |
| | 4910; mP) | 98 | 150 | 126.9 | 137.6 |
| 7 (Comp.) | Ac PSA/AC core | 60 | 120 | 63.5 | 265.7 |
| | foamed with | 98 | 120 | 64.1 | 181.8 |
| | hollow glass | 154 | 120 | 69.4 | 142.5 |
| | beads/Ac PSA | 210 | 120 | 67.1 | 118.9 |
| | (3M ™ VHB ™ | | | | |
| | 4991) | | | | |
| 8 (Comp.) | Ac PSA/AC core | 60 | 120 | 59.8 | 244.3 |
| | foamed with | 98 | 120 | 65.1 | 174.7 |
| | hollow glass | 154 | 120 | 72.4 | 132.0 |
| | beads/Ac PSA | 210 | 120 | 78.8 | 125.1 |
| | (3M ™ VHB ™ | 60 | 150 | 52.9 | 170.6 |
| | 4991; mP) | 98 | 150 | 58.0 | 157.6 |

1. Adhesive tape comprising a thickness of at least 150 μm, wherein the adhesive tape after storage at 120 to 150° C. over 60 to 210 days has an extendability in machine direction to at least three times its original extent.

2. The adhesive tape according to claim 1, characterized in that the adhesive tape comprises at least one thermally crosslinked polymer.

3. The adhesive tape according to claim 1 comprising at least one pressure-sensitive adhesive layer comprising at least one polymer selected from the group consisting of poly(meth)acrylates, synthetic rubbers, vinylaromatic block copolymers, polyolefins and mixtures thereof.

4. The adhesive tape according to claim 3 comprising at least one pressure-sensitive adhesive layer comprising at least one poly(meth)acrylate.

5. The adhesive tape according to claim 1 wherein the thickness of the adhesive tape is between 200 to 5500 μm.

6. The adhesive tape according to claim 1 wherein the adhesive tape comprises at least one foamed layer.

7. The adhesive tape according to claim 6 wherein the foamed layer consists of a closed-cell foam.

8. The adhesive tape according to claim 6 wherein the foamed layer comprises a syntactic foam.

9. The adhesive tape according to claim 6 wherein the foamed layer comprises at least one poly(meth)acrylate base layer.

10. Device comprising a component bonded on one side with a double-sided adhesive tape according to claim 1, and a heat-resistant release liner applied to the side of the adhesive tape that is not joined to the component.
